(19) United States
(12) Patent Application Publication
(10) Pub. No.: US 2014/0125602 A1
(43) Pub. Date: May 8, 2014

(54) TOUCH DISPLAY DEVICE

(71) Applicant: PRIMAX ELECTRONICS LTD., Neihu (TW)

(72) Inventor: Chung-Yuan Chen, Neihu (TW)

(73) Assignee: PRIMAX ELECTRONICS LTD., Neihu (TW)

(21) Appl. No.: 13/689,974

(22) Filed: Nov. 30, 2012

(30) Foreign Application Priority Data
Nov. 6, 2012 (TW) 101141145

(51) Int. Cl. G06F 3/023

(52) U.S. Cl. CPC G06F 3/023
USPC 345/173; 345/87

(57) ABSTRACT

A touch display device includes a display panel and a touch-sensitive board. The touch-sensitive board includes an anti-glare structure and a touch-sensitive membrane. The anti-glare structure is used for inhibiting glare. The touch-sensitive membrane is disposed on a surface of the anti-glare structure for sensing the positions of the user's fingers or other indicants. Since the touch-sensitive membrane is disposed on the anti-glare structure, it is not necessary to provide an additional plastic substrate to install the touch-sensitive membrane thereon. Consequently, the thickness of the touch display device can be reduced.

### FIELD OF THE INVENTION

The present invention relates to a touch display device, and more particularly to a touch display device with an anti-glare structure and a touch-sensitive membrane, in which the touch-sensitive membrane is disposed on the anti-glare structure.

### BACKGROUND OF THE INVENTION

Display devices are widely applied to various common electronic devices. For example, display devices may be used as the display screens of mobile phones, televisions, computers or other electronic devices in order display images or human-machine interaction interfaces. The images or the human-machine interaction interfaces shown on the display devices may facilitate the users to control the electronic devices. As known, if the human-machine interaction efficacy is enhanced, the user may operate the electronic device more intuitively. For enhancing the human-machine interaction efficacy, some kinds of display devices with touch-sensitive functions have been introduced into the markets. The display device with the touch-sensitive function is also referred as a touch display device. By touching the touch display device with fingers or other indicants, the user can easily operate the electronic device without the need of installing an additional human-machine interface device (e.g. a mouse or a keyboard).

A conventional touch display device comprises a protective plate, a touch-sensitive board, a light guide plate, and a display panel. The protective plate is used as a topmost layer of the touch display device in order to protect the touch-sensitive board, the light guide plate and the display panel from being damaged by foreign objects. The touch-sensitive board is disposed over the light guide plate and the display panel for sensing the positions of the user's fingers or other indicants. Generally, the current touch-sensitive board is produced by performing a coating process or a screen printing process to form one or more electrode layers on a plastic substrate.

The light guide plate is used for transferring a light beam in order to increase the luminance of the touch display device. The display panel is used for displaying an image or a human-machine interaction interface. Depending on the properties of the display panel, the light guide plate may be disposed over the display panel (i.e. a front lighting design), or the light guide plate may be disposed under the display panel (i.e. a back lighting design).

From the above discussions, the touch display device is produced by stacking plural plates or layers on each other. Since the plastic substrate of the touch-sensitive board has a specified thickness, after the touch-sensitive board is installed in the touch display device, the overall height of the touch display device is bound to be increased. In a case that the touch display device is applied to an electronic device, the increased height of the touch display device is detrimental to miniaturization of the electronic device. Under this circumstance, the market competitiveness of the electronic device is impaired.

### SUMMARY OF THE INVENTION

The present invention provides a slim-type touch display device.

In accordance with a first aspect of the present invention, there is provided a touch display device. The touch display device includes a display panel, a light guide plate, and a touch-sensitive board. The light guide plate is used for transferring a light beam. The touch-sensitive board is disposed over the display panel and the light guide plate. The touch-sensitive board includes an anti-glare structure and a touch-sensitive membrane. The anti-glare structure is used for inhibiting glare. The touch-sensitive membrane is disposed on a bottom surface of the anti-glare structure. The touch-sensitive membrane includes a first electrode layer, a second electrode layer and a spacer layer. The spacer layer is arranged between the first electrode layer and the second electrode layer.

In an embodiment, the first electrode layer and the second electrode layer are made of carbon nanotubes.

In an embodiment, the first electrode layer and the second electrode layer are made of nano silver.

In an embodiment, the anti-glare structure comprises a plastic substrate and an anti-glare film.

In an embodiment, the display panel is a liquid crystal panel.

In an embodiment, the display panel is an electronic paper panel.

In an embodiment, the light guide plate is disposed over the display panel.

In an embodiment, the light guide plate is disposed under the display panel.

In an embodiment, the touch display device further includes a reflector. The reflector is disposed under the light guide plate.

In an embodiment, the touch display device further includes a light source. The light source is located at a side of the light guide plate.

In an embodiment, the light guide plate further includes a microstructural layer.

In an embodiment, the microstructural layer is made of a UV-curable paint.

In an embodiment, the microstructural layer is formed on a surface of the light guide plate by a hot embossing process.

In accordance with a second aspect of the present invention, there is provided a touch display device. The touch display device includes a display panel, a light guide plate, a light source, and a touch-sensitive board. The light guide plate is disposed over the display panel for transferring a light beam. The light source is located at a side of the light guide plate. The touch-sensitive board is disposed over the light guide plate. The touch-sensitive board includes an anti-glare structure and a touch-sensitive membrane. The anti-glare structure is used for inhibiting glare. The touch-sensitive membrane is disposed on a bottom surface of the anti-glare structure. The touch-sensitive membrane includes a first electrode layer, a second electrode layer and a spacer layer. The spacer layer is arranged between the first electrode layer and the second electrode layer.

In an embodiment, the first electrode layer and the second electrode layer are made of carbon nanotubes.

In an embodiment, the first electrode layer and the second electrode layer are made of nano silver.

In an embodiment, the anti-glare structure comprises a plastic substrate and an anti-glare film.

In an embodiment, the display panel is a liquid crystal panel.

In an embodiment, the display panel is an electronic paper panel.

In an embodiment, the light guide plate further includes a microstructural layer.

In an embodiment, the microstructural layer is made of a UV-curable paint.

In an embodiment, the microstructural layer is formed on a surface of the light guide plate by a hot embossing process.

In accordance with a third aspect of the present invention, there is provided a touch display device. The touch display device includes a display panel, a light guide plate, a reflector, a light source, and a touch-sensitive board. The light guide plate is disposed under the display panel for transferring a light beam. The reflector is disposed under the light guide plate. The light source is located at a side of the light guide plate. The touch-sensitive board is disposed over the display panel. The touch-sensitive board includes an anti-glare structure and a touch-sensitive membrane. The anti-glare structure is used for inhibiting glare. The touch-sensitive membrane is disposed on a bottom surface of the anti-glare structure. The touch-sensitive membrane includes a first electrode layer, a second electrode layer and a spacer layer. The spacer layer is arranged between the first electrode layer and the second electrode layer.

In an embodiment, the first electrode layer and the second electrode layer are made of carbon nanotubes.

In an embodiment, the first electrode layer and the second electrode layer are made of nano silver.

In an embodiment, the anti-glare structure comprises a plastic substrate and an anti-glare film.

In an embodiment, the display panel is a liquid crystal panel.

In an embodiment, the display panel is an electronic paper panel.

In an embodiment, the light guide plate further includes a microstructural layer.

In an embodiment, the microstructural layer is made of a UV-curable paint.

In an embodiment, the microstructural layer is formed on a surface of the light guide plate by a hot embossing process.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the components of a touch display device according to a first embodiment of the present invention; and

FIG. 2 schematically illustrates the components of a touch display device according to a second embodiment of the present invention.

### DETAILED DESCRIPTION OF THE PREFERRED EMBODIMENT

The present invention provides a touch display device. The touch display device may be applied to a display screen of an electronic device (e.g. a mobile phone, a television or a computer) in order to display an image or a human-machine interaction interface. In addition, the touch display device has a touch-sensitive function.

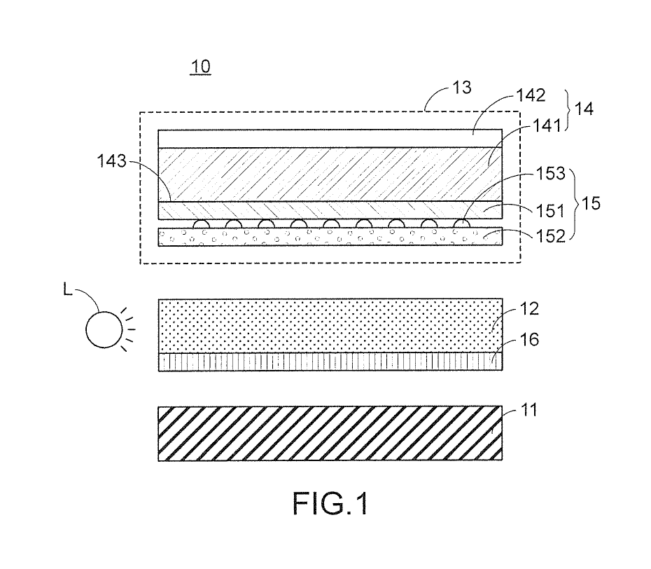

Hereinafter, a touch display device according to a first embodiment of the present invention will be illustrated with reference to FIG. 1. FIG. 1 schematically illustrates the components of a touch display device according to a first embodiment of the present invention. As shown in FIG. 1, the touch display device 10 comprises a light source L, a display panel 11, a light guide plate 12, and a touch-sensitive board 13. The light source L is located at a side of the light guide plate 12 for emitting a light beam. The display panel 11 is used for displaying an image or a human-machine interaction interface. The light guide plate 12 is used for transferring the light beam. The touch-sensitive board 13 is disposed over the display panel 11 and the light guide plate 12 for protecting the display panel 11 and the light guide plate 12 and implementing the touch-sensitive function of the touch display device 10.

For example, the light source L is a light emitting diode (LED). The light guide plate 12 is made of a transparent material. An example of the transparent material includes but is not limited to polycarbonate (PC), polyethylene terephthalate (PET) or silicone resin.

An example of the display panel 11 includes but is not limited to a liquid crystal panel or an electronic paper panel. Depending on the properties of the display panel, the light guide plate 12 may be disposed over the display panel 11 or under the display panel 11. In this embodiment, the display panel 11 is a light-transmissible panel or an opaque panel. Moreover, in this embodiment, the light guide plate 12 is disposed over the display panel 11 (i.e. a front lighting design).

Please refer to FIG. 1 again. As shown in FIG. 1, the touch-sensitive board 13 comprises an anti-glare structure 14 and a touch-sensitive membrane 15. The anti-glare structure 14 comprises a plastic substrate 141 and an anti-glare film 142. The touch-sensitive membrane 15 comprises a first electrode layer 151, a second electrode layer 152 and a spacer layer 153. The plastic substrate 141 is also made of a transparent material. An example of the transparent material includes but is not limited to polycarbonate (PC), polyethylene terephthalate (PET) or silicone resin. In some other embodiments, the anti-glare structure 14 comprises a glass substrate and an anti-glare film.

The anti-glare structure 14 may be produced by a dip coating process, a spray coating process, a vacuum evaporation process or any other conventional optical coating process. For example, by coating plural light-transmissible particles on a top surface of the plastic substrate 141, the anti-glare film 142 may be produced. The way of producing the anti-glare film 142 is presented herein for purpose of illustration and description only. Due to the rough surface of the anti-glare film 142, the light beam irradiated on the anti-glare structure 14 is readily scattered by the anti-glare film 142. Under this circumstance, since the fraction of the light beam which is centralized at a specified angle is reduced, the possibility of causing discomfort of the user is minimized and the anti-glare purpose is achieved.

The touch-sensitive membrane 15 is disposed on a bottom surface 143 of the anti-glare structure 14 for sensing the positions of the user's fingers or other indicants. The spacer layer 153 is arranged between the first electrode layer 151 and the second electrode layer 152. Due to the spacer layer 153, the first electrode layer 151 and the second electrode layer 152 are separated from each other and electrically isolated from each other.

The touch-sensitive membrane 15 may be formed by a screen printing process, but is not limited thereto. Moreover, the touch-sensitive membrane 15 may be a resistive touch-sensitive membrane or a capacitive touch-sensitive membrane. Moreover, the first electrode layer 151 and the second electrode layer 152 are made of carbon nanotubes or nano silver, but are not limited thereto.

From the above discussions, the plastic substrate 141 is capable of forming the anti-glare film 142 thereon. Moreover, since the plastic substrate 141 is able to prevent the foreign objects from being directly contacted with the display panel 11, the light guide plate 12 or the touch-sensitive membrane 15, the plastic substrate 141 has a protecting function. Alternatively, in some other embodiments, a top surface of the plastic substrate 141 may be equipped with another optical coating film (such as an anti-reflection film, a waterproof film or an anti-fingerprint film) in order to increase the stain resistance of the touch display device 10 and enhance the comfort of operating the touch display device 10.

In order to increase the luminance of the display panel 11, the light beam within the light guide plate 12 should be effectively transmitted through the light guide plate 12. For achieving this purpose, the light guide plate 12 further comprises a microstructural layer 16, but is not limited thereto. In this embodiment, the microstructural layer 16 is disposed on a surface of the light guide plate 12 (e.g. a bottom surface of the light guide plate 12). Moreover, the microstructural layer 16 is formed on the bottom surface of the light guide plate 12 by coating a UV-curable paint, or the microstructural layer 16 is formed on the bottom surface of the light guide plate 12 by a hot embossing process. The way of forming the microstructural layer 16 is presented herein for purpose of illustration and description only.

Moreover, different plates or boards of the touch display device 10 (e.g. the display panel 11 and the light guide plate 12, or the light guide plate 12 and the touch-sensitive board 13) may be combined together via an adhesive such as an optical clear adhesive (OCA) or an optical clear resin (OCR), but is not limited thereto.

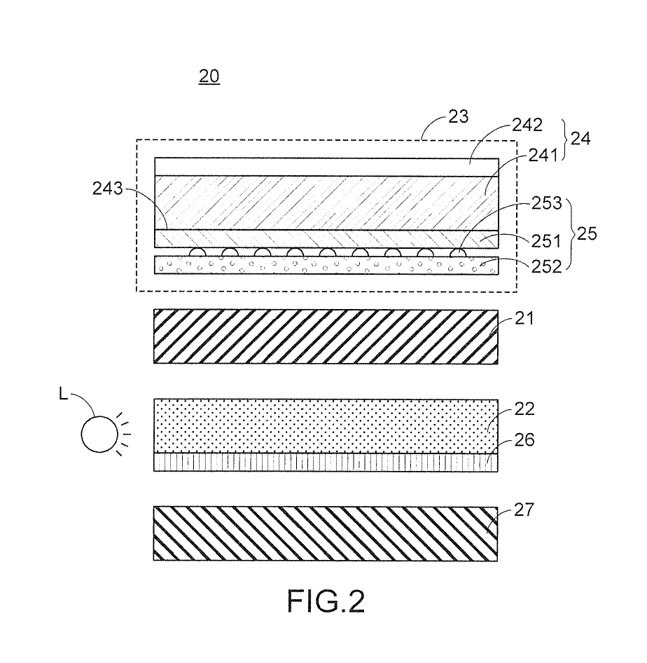

Hereinafter, a touch display device according to a second embodiment of the present invention will be illustrated with reference to FIG. 2. FIG. 2 schematically illustrates the components of a touch display device according to a second embodiment of the present invention. As shown in FIG. 2, the touch display device 20 comprises a light source L, a display panel 21, a light guide plate 22, a touch-sensitive board 23, and a reflector 27. The light guide plate 22 further comprises a microstructural layer 26. The touch-sensitive board 23 comprises an anti-glare structure 24 and a touch-sensitive membrane 25. The anti-glare structure 24 comprises a plastic substrate 241 and an anti-glare film 242. The touch-sensitive membrane 25 comprises a first electrode layer 251, a second electrode layer 252 and a spacer layer 253.

In comparison with the first embodiment of FIG. 1, the touch display device 20 of this embodiment has a back lighting design and further comprises a reflector 27 under the light guide plate 22. The configurations of the other components of the touch display device 20 are substantially identical to those of the touch display device 10 of the first embodiment, and are not redundantly described herein. It is noted that only the light-transmissible panel (e.g. a liquid crystal panel) is suitably used as the display panel of the back-lighting touch display device. If the opaque panel is used as the display panel of the back-lighting touch display device, the light beam is unable to be transmitted through the opaque panel, and thus the luminance of the display panel 21 fails to be increased.

In this embodiment, as shown in FIG. 2, the display panel 21 is a light-transmissible panel. In addition, since the light guide plate 22 is disposed under the display panel 21, the touch display device 20 has a back lighting design. In the back lighting design, the touch display device 20 may further comprise the reflector 27. The reflector 27 is disposed under the light guide plate 22 for increasing the reflectivity of the light beam, so that the luminance of the display panel 21 is enhanced.

From the above descriptions, the present invention provides a touch display device. The touch display device comprises a display panel, a light guide plate, and a touch-sensitive board. The touch-sensitive board touch-sensitive board comprises an anti-glare structure and a touch-sensitive membrane. The touch-sensitive membrane is disposed on a bottom surface of the anti-glare structure for sensing the positions of the user's fingers or other indicants. In accordance with the present invention, the touch-sensitive membrane is disposed on the anti-glare structure to achieve the touch-sensitive function of the touch display device without the need of installing an additional plastic substrate. Under this circumstance, since the overall height of the touch display device can be further reduced, the touch display device becomes slim.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A touch display device, comprising:
a display panel;
a light guide plate for transferring a light beam; and
a touch-sensitive board disposed over said display panel and said light guide plate, and comprising
an anti-glare structure for inhibiting glare; and
a touch-sensitive membrane disposed on a bottom surface of said anti-glare structure, wherein said touch-sensitive membrane comprises a first electrode layer, a second electrode layer and a spacer layer, wherein said spacer layer is arranged between said first electrode layer and said second electrode layer.

2. The touch display device according to claim 1, wherein said first electrode layer and said second electrode layer are made of carbon nanotubes.

3. The touch display device according to claim 1, wherein said first electrode layer and said second electrode layer are made of nano silver.

4. The touch display device according to claim 1, wherein said anti-glare structure comprises a plastic substrate and an anti-glare film.

5. The touch display device according to claim 1, wherein said display panel is a liquid crystal panel.

6. The touch display device according to claim 1, wherein said display panel is an electronic paper panel.

7. The touch display device according to claim 1, wherein said light guide plate is disposed over said display panel.

8. The touch display device according to claim 1, wherein said light guide plate is disposed under said display panel.

9. The touch display device according to claim 8, further comprising a reflector, which is disposed under said light guide plate.

10. The touch display device according to claim 1, wherein said touch display device further comprises a light source, and said light source is located at a side of said light guide plate.

11. The touch display device according to claim 1, wherein said light guide plate further comprises a microstructural layer.

12. The touch display device according to claim 11, wherein said microstructural layer is made of a UV-curable paint.

13. The touch display device according to claim 11, wherein said microstructural layer is formed on a surface of said light guide plate by a hot embossing process.

14. A touch display device, comprising:
a display panel;
a light guide plate disposed over said display panel for transferring a light beam;
a light source located at a side of said light guide plate; and
a touch-sensitive board disposed over said light guide plate, and comprising
an anti-glare structure for inhibiting glare; and
a touch-sensitive membrane disposed on a bottom surface of said anti-glare structure, wherein said touch-sensitive membrane comprises a first electrode layer, a second electrode layer and a spacer layer, wherein said spacer layer is arranged between said first electrode layer and said second electrode layer.

15. The touch display device according to claim 14, wherein said first electrode layer and said second electrode layer are made of carbon nanotubes.

16. The touch display device according to claim 14, wherein said first electrode layer and said second electrode layer are made of nano silver.

17. The touch display device according to claim 14, wherein said anti-glare structure comprises a plastic substrate and an anti-glare film.

18. The touch display device according to claim 14, wherein said display panel is a liquid crystal panel.

19. The touch display device according to claim 14, wherein said display panel is an electronic paper panel.

20. The touch display device according to claim 14, wherein said light guide plate further comprises a microstructural layer.

21. The touch display device according to claim 20, wherein said microstructural layer is made of a UV-curable paint.

22. The touch display device according to claim 20, wherein said microstructural layer is formed on a surface of said light guide plate by a hot embossing process.

23. A touch display device, comprising:
a display panel;
a light guide plate disposed under said display panel for transferring a light beam;
a reflector disposed under said light guide plate;
a light source located at a side of said light guide plate; and
a touch-sensitive board disposed over said display panel, and comprising
an anti-glare structure for inhibiting glare; and
a touch-sensitive membrane disposed on a bottom surface of said anti-glare structure, wherein said touch-sensitive membrane comprises a first electrode layer, a second electrode layer and a spacer layer, wherein said spacer layer is arranged between said first electrode layer and said second electrode layer.

24. The touch display device according to claim 23, wherein said first electrode layer and said second electrode layer are made of carbon nanotubes.

25. The touch display device according to claim 23, wherein said first electrode layer and said second electrode layer are made of nano silver.

26. The touch display device according to claim 23, wherein said anti-glare structure comprises a plastic substrate and an anti-glare film.

27. The touch display device according to claim 23, wherein said display panel is a liquid crystal panel.

28. The touch display device according to claim 23, wherein said display panel is an electronic paper panel.

29. The touch display device according to claim 23, wherein said light guide plate further comprises a microstructural layer.

30. The touch display device according to claim 29, wherein said microstructural layer is made of a UV-curable paint.

31. The touch display device according to claim 29, wherein said microstructural layer is formed on a surface of said light guide plate by a hot embossing process.
